(19) United States
(12) Patent Application Publication
(10) Pub. No.: US 2008/0173690 A1
(43) Pub. Date: Jul. 24, 2008

(54) Slap hammer with cap magazine and feeder

(75) Inventor: Frederick W. Lamb, McCalla, AL (US)

Correspondence Address: Russell H. Walker;Walker, McKenzie & Walker, P.C., Suite 434, 6363 Poplar Avenue, Memphis, TN, 38119-4896, US

(73) Assignee: PneuTools, Incorporated, Memphis, TN (US)

(21) Appl. No.: 11/657,395

(22) Filed: Jan. 23, 2007

(51) Int. Cl. B25C 5/11

(52) U.S. Cl. 227/133

(57) ABSTRACT

A manual slap hammer having a staple magazine, a stapler body, a cap magazine, and a cap feeder. The cap feeder has a footplate mounted to the slap hammer, a cap pusher mounted for reciprocation with respect to the footplate, and a linkage operably connecting the cap pusher to a forward end of the stapler body. When the slap hammer strikes a workpiece, the forward end of the stapler body moves downwardly by inertia toward the forward end of the staple magazine, such that the linkage moves the cap pusher to a first position. As the forward end of the stapler body moves away from the staple magazine following stapling, the linkage moves the cap pusher to a second position, thereby causing the next cap to be moved into stapling position.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO COMPACT DISC(S)

Not applicable.

### BACKGROUND OF THE INVENTION

1. Field of the Invention

The present invention relates, in general, to manual staplers and fastener applicators, and in particular, to manual staplers and fastener applicators for inserting fasteners into fastener caps intended to be used as a washers for holding roofing paper, insulation wrap, and coverings to houses, lumber, and other articles in the construction industry.

2. Information Disclosure Statement

Well-known plastic fastener caps washers are often used to hold down roofing paper, insulation wrap, and coverings on houses, buildings, lumber, and other structures in the construction industry. Often powered nail guns and staplers are used to drive staples and the like through the fastener caps. Such fastener caps are well known and are shown in FIGS. 8, 9, and 10 of the drawings herein. In some applications, unpowered manual staplers and palm nailers are used to drive staples and nails into fastener caps. So-called “slap hammers” are known in the prior art that have a magazine of staples that are applied one by one to fasten insulation wrap, roofing paper, and the like to structures. In use, a slap hammer is held in a worker's hand and swung in an arc toward the workpiece. When the nose of the slap hammer strikes (“slaps”) the workpiece, the inertia of the head of the slap hammer causes a driver blade to drive the leading staple from the staple magazine into the workpiece. An advantage of slap hammers is that they are unpowered and also that staples can rapidly be applied to a workpiece by repeated swings of the slap hammer. However, it is not heretofore known in the prior art, and was not previously believed possible, to have a magazine on a slap hammer to somehow automatically feed fastener caps under the slap hammer with each stroke of slap hammer against the workpiece. Accordingly, when being used to affix cap fasteners to a workpiece, slap hammers have not heretofore had the rapid stapling rate that powered fastener guns provided because a cap must be placed on the workpiece prior to each swing of the slap hammer.

It is therefore desirable to have a slap hammer with a magazine and feeder that feeds a cap fastener under the staple prior to each striking of the workpiece with the cap fastener.

### BRIEF SUMMARY OF THE INVENTION

The present invention is an improved slap hammer with a staple magazine, wherein the improvement comprises a cap magazine and a feeder to feed a cap under each staple as the staple is inserted into the workpiece.

It is an object of the present invention to provide an improved slap hammer with a cap magazine and cap feeder.

### BRIEF DESCRIPTION OF THE SEVERAL VIEWS OF THE DRAWING

FIG. 1 is a side view of the slap hammer of the present invention, showing movement of the cap pusher on the cap magazine.

FIG. 2 is a perspective view of the slap hammer of the present invention, showing a portion of the underside.

FIG. 3 is another perspective view of a portion of the underside of the slap hammer of the present invention.

FIG. 4 is a perspective view of the cap feeder of the present invention, showing movement of the cap pusher by the linkage to the stapler head.

FIG. 5 is a perspective view of selected parts of the cap feeder of the present invention, showing the cap pusher in the first position prior to feeding the leading cap.

FIG. 6 is a perspective view of selected parts of the cap feeder of the present invention, similar to FIG. 5 except showing the cap pusher in the second position after feeding the leading cap into the stapling position.

FIG. 7 is a perspective view of selected parts of the cap feeder of the present invention, similar to FIG. 5 except with the entrapment plate atop the cap pusher and footplate.

FIG. 8 is a top plan view of a prior art cap fastener with a staple therethrough.

FIG. 9 is a side sectional view of a prior art cap fastener.

FIG. 10 is a side sectional view of a prior art cap fastener with a staple therethrough into a workpiece.

FIG. 11 is an exploded parts diagram of the present invention, showing the various parts and how they fit together.

### DETAILED DESCRIPTION OF THE INVENTION

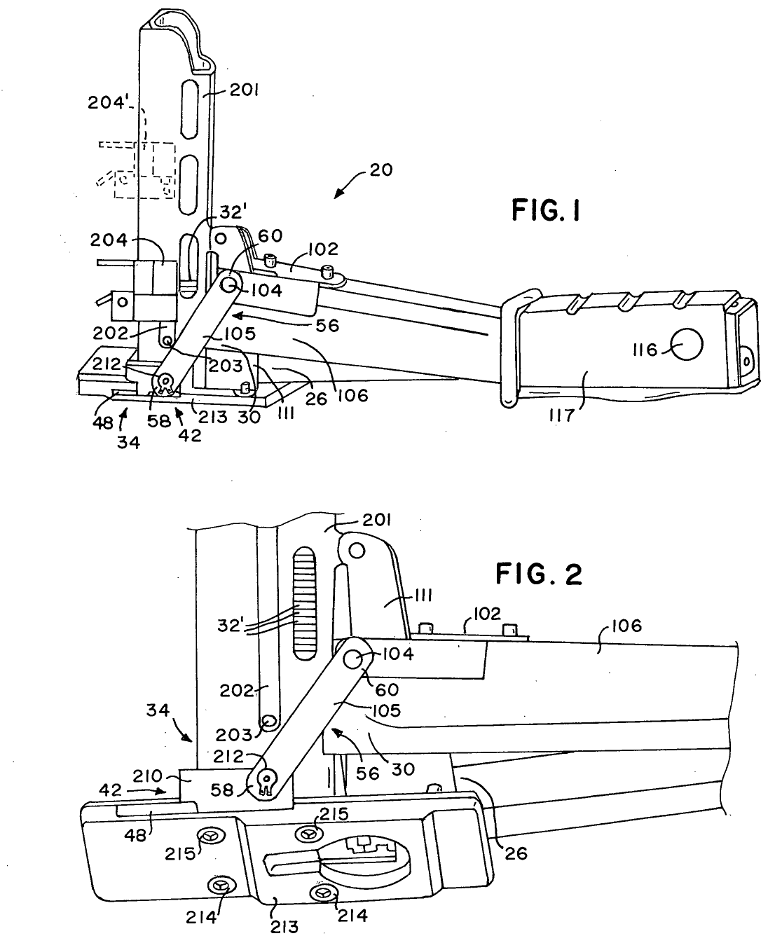

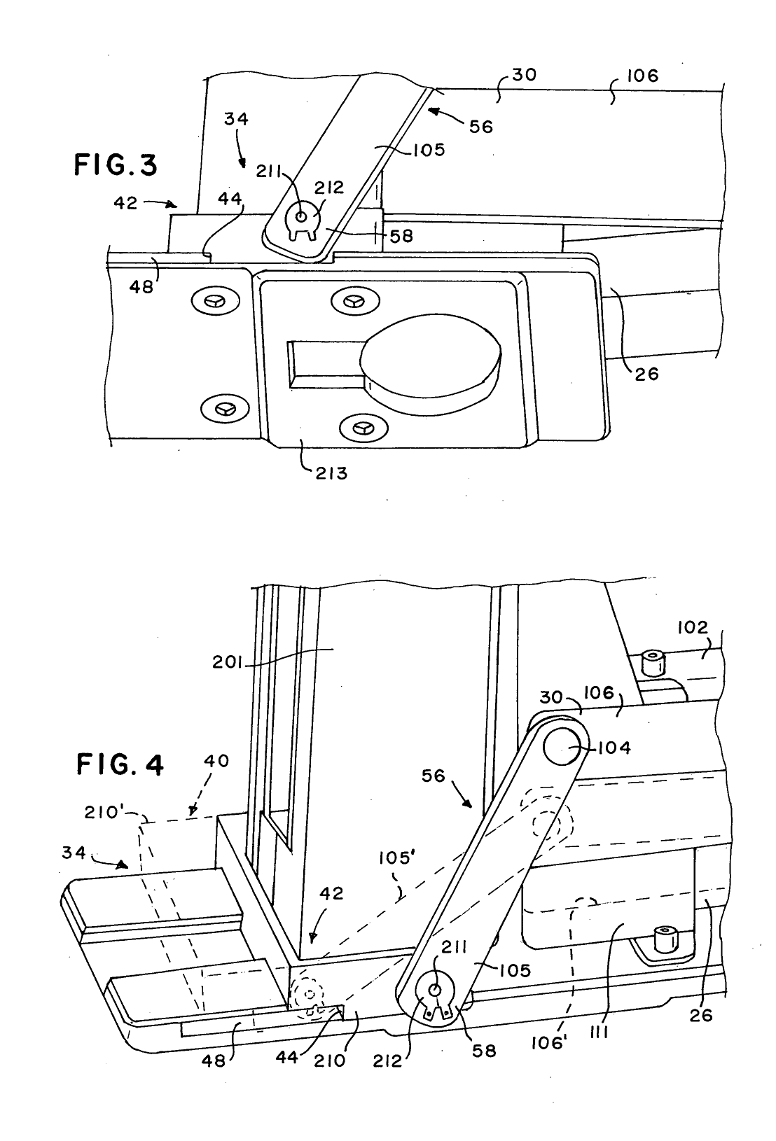

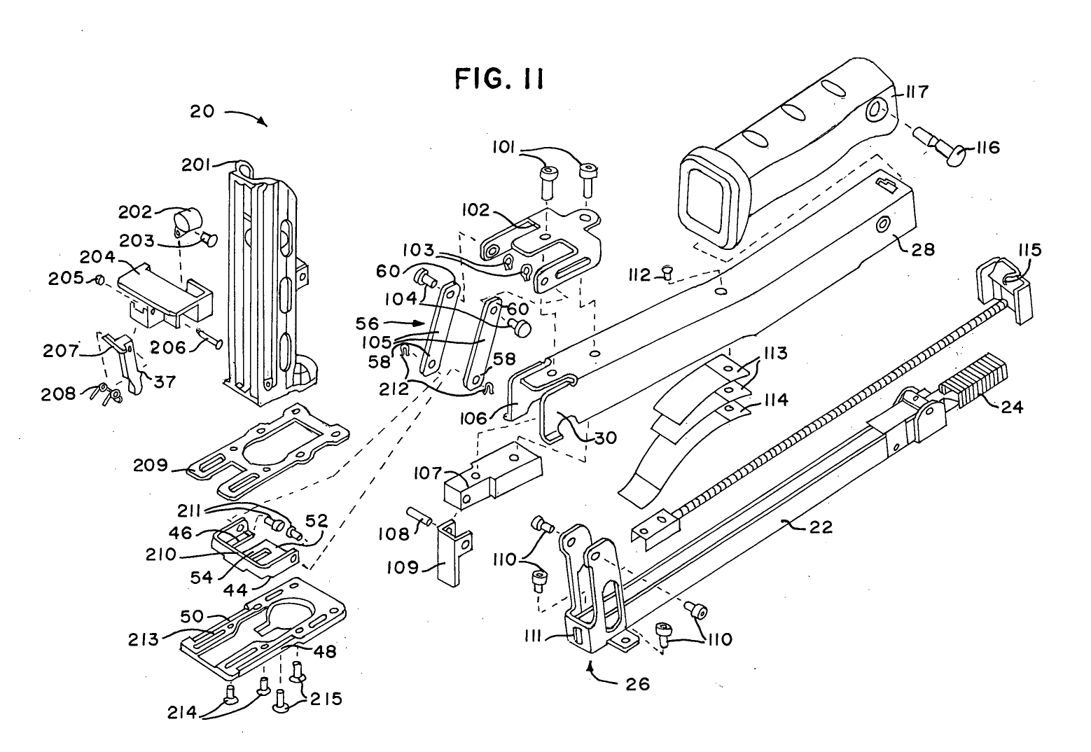

Referring to FIGS. 1-7 and 11, slap hammer 20 is seen to comprise a well-known staple magazine 22 into which is received a plurality of well-known staples 24 that are urged toward the forward staple magazine end 26 of staple magazine 22 by a well-known staple pusher 115 that is received into the rear of staple magazine 22. A well-known stapler body 106 is pivotally mounted at its rear end 28 to stapler magazine 22 by a pivot axle 116 passing through handle 117 so that the forward body end 30 of stapler body 106 is mounted for up and down movement with respect to forward staple magazine end 26.

A staple driver blade 109 is mounted proximate forward body end 30 of stapler body 106 for joint up and down motion therewith so as to engagingly drive a staple through a well-known fastener cap 32, through a material such as roofing paper 34, and into a workpiece 36 so as to produce, for example, roofing paper 34 that is entrapped and held down to workpiece 36 as shown in FIGS. 8 and 10.

It is typical in the prior art to have staple driver blade 109 be fixedly mounted to the front of a weight 107, hereinafter described. However, in the improved slap hammer 20 of the present invention, in order to get a sufficient reciprocation stroke of cap pusher 210, hereinafter described, the up-and-down stroke of staple driver blade 109 had to be increased over the prior art, which necessitated making staple driver blade 109 longer than typically found in prior art slap hammers. The longer staple driver blade 109 therefore was made to be pivotally mounted to weight 107 to avoid jamming of staple driver blade 109. Accordingly, staple driver blade 109 is preferably pivotally mounted about a pin 108 to a weight 107 that is mounted within the forward body end 30 of stapler body 106 so as to provide additional inertial mass to forward body end 30, thereby causing staple driver blade 109 to heavily impact the driven staple into the workpiece as the slap hammer is swiftly swung by a worker onto the workpiece in a manner well-known to those skilled in the art. A plurality of leaf springs 113, 114 are mounted to stapler body 106 by a rivet 112 and urge the forward body end 30 of stapler body 106 away from the forward end 26 of staple magazine 22, so as to move staple driver blade 109 to above the next leading staple after the current staple has been driven into the workpiece. Weight 107 is mounted to stapler body 106 by a pair of screws 101, which also mount linkage bracket 102 to stapler body 106 for use by the improvement of the present invention.

The improvement of the improved slap hammer 20 of the present invention comprises a cap magazine 201, preferably a vertically-oriented tower as shown, that holds a stacked supply of fastener caps 32, and a cap feeder 34 for feeding a cap 32 from the stacked supply of caps 32′ to a stapling position 36 (seen best in FIG. 6) under the staple driver blade 109. A cap stack pusher body 204 is mounted for up and down movement upon cap magazine 201, and a spring 202, mounted within cap stack pusher body 204 and with a lower end of spring 202 being held to cap magazine 201 by a screw 203, causes cap stack pusher body 204 to be forcibly pulled downward from upper positions such as position 204′ shown in FIG. 1. A cap stack pusher arm 207 is pivotally mounted to cap stack pusher body 204 by an axle 206 and fastener 205, with a spring 208 causing the bottom of cap stack pusher arm 207 to be urged inwardly toward cap magazine 201. An inwardly-extending pawl 37 on cap stack pusher arm 207 engages the top of the uppermost cap 32′ in the stack of caps, thereby urging the stack of caps downward toward the cap feeder 34 and holding the caps within the cap magazine as the slap hammer is swung.

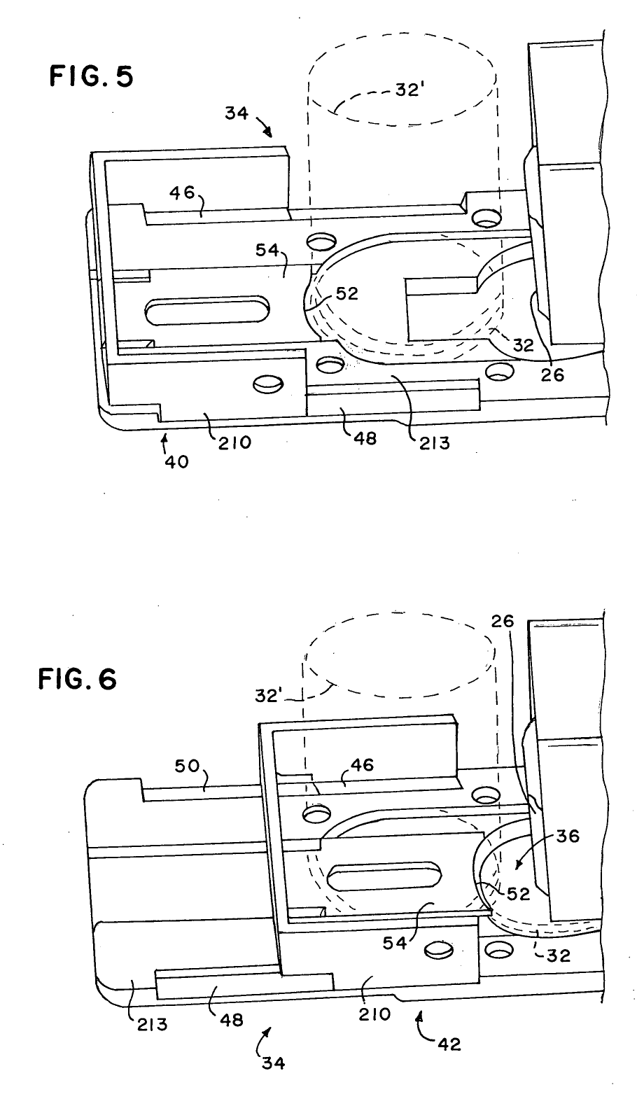

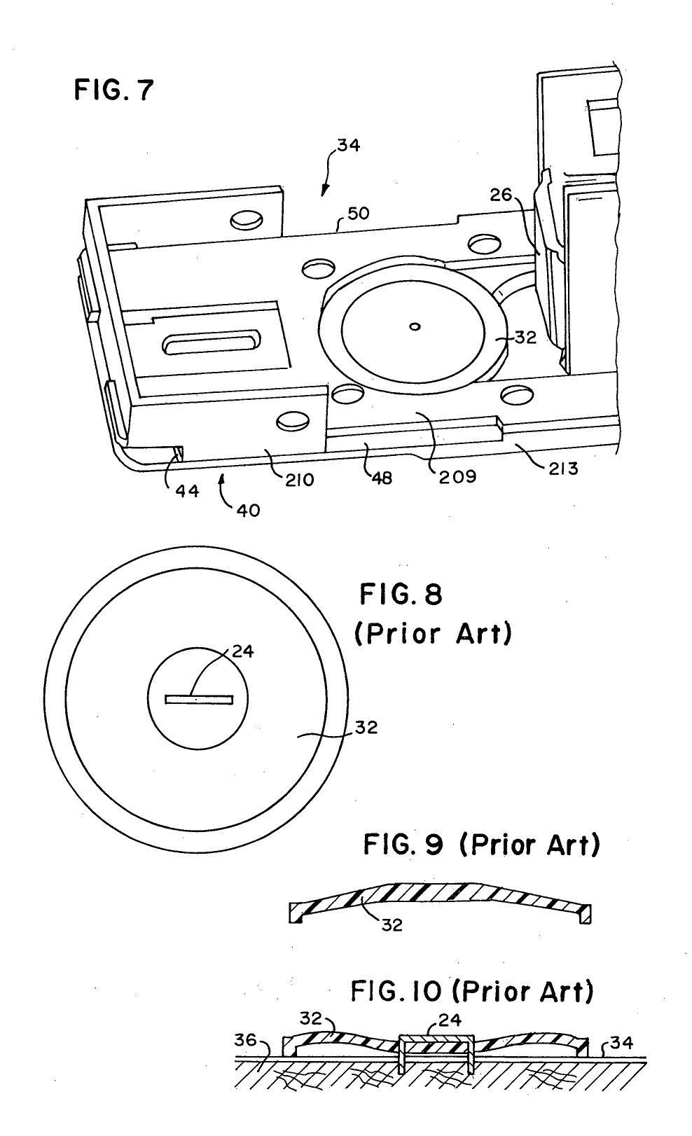

Cap feeder 34 comprises a footplate 213 mounted to slap hammer 20 by screws 214, 215 that engage with the underside of cap magazine 201. To provide additional support for cap magazine 201, a cap magazine mounting bracket 111 also mounts cap magazine 201 to footplate 213 using four screws 110, with the forward end 26 of staple magazine 22 being within cap magazine mounting bracket 111. Cap feeder 34 also comprises a cap pusher 210 mounted for forward and backward reciprocation upon footplate 213 from a first position 40, with cap pusher shown in dotted outline as 210′ in FIG. 4 and shown in solid lines in FIGS. 5 and 7, to a second position 42 shown in solid lines in FIGS. 1, 2, 3, 4, and 6.

Cap pusher 210 preferably has left and right tabs 44, 46 that respectively reciprocate within left and right lateral slots 48, 50 in footplate 213, and cap pusher 210 is held entrapped to footplate 213 by entrapment plate 209 that sits atop cap pusher 210. Cap pusher 210 has a cap engaging portion, preferably a curved end 52 of a rearwardly-extending finger 54, that engagingly mates with the curved circumference of cap 32 to feed cap 32 from the stacked supply of caps 32′ to the stapling position 36 under the staple driver blade 109.

Cap feeder 34 further comprises a linkage 56 operably connecting cap pusher 210 to forward body end 30 of stapler body 106. Preferably linkage 56 comprises one and preferably two rigid linkage arms 105, one on either side of slap hammer 20, with each linkage arm 105 having a first arm end 58 pivotally mounted to cap pusher 210 by a pivot axle 211 and C-clip 212, and having a second arm end 60 pivotally mounted to forward body end 30 of slap hammer 20 as by pivot axle 104 and C-clip 103 mounting second arm end 60 to linkage bracket 102 that is mounted to forward body end 30. Linkage 56 is seen to operably connect cap pusher 210 to forward body end 30 of stapler body 106 such that, when footplate 213 is in contact with the workpiece and staple driver blade 109 has driven a staple into the workpiece, cap pusher 210 is reciprocated by linkage 56 into first position 40 preparatory to feeding cap 32 from the stacked supply of caps 32′, and such that, when footplate 213 is then removed from contact with the workpiece, cap pusher 210, with cap engaging portion 52 being in engagement with cap 32 from the stacked supply of caps 32′, is reciprocated by linkage 56 into second position 42 as cap 32 from stacked supply of caps 32′ is moved into the stapling position under the driver blade. The slap hammer is thus primed to staple the next cap 32, which is now in the stapling position. Linkage arm 105 and stapler body 106 are shown in dotted outline in FIG. 4 as 105′ and 106′, respectively, when the cap pusher 210 is in the first position.

To use the improved slap hammer of the present invention, the staple magazine 22 is first filled with staples 24 and the cap magazine is then filled with a stack of caps 32′. The slap hammer is held by the handle 117 and swung with force toward a workpiece, and, as the footplate 213 contacts the workpiece, the inertia of stapler head weight 107 will cause the forward end 30 of stapler body 106 to continue to move toward the workpiece (and thus toward forward end 26 of stapler magazine 22) after impact with the workpiece stops movement of the footplate 213, thereby causing the staple driver blade 109 to drive the next staple through the fastener cap 32, which is in the stapling position, and into the workpiece as linkage 56 causes cap pusher 210 to move into the first position 40. After the staple has been driven through the fastener cap 32 and into the workpiece, springs 113, 114 will cause the forward end 30 of stapler body 106 to move away from the forward end 26 of staple magazine 22, thereby causing linkage 56 to move cap pusher 210 from first position 40 to second position 42, thereby moving the next cap 32 from the bottom of stack of caps 32′ and into the stapling position 36.

Although the present invention has been described and illustrated with respect to a preferred embodiment and a preferred use therefor, it is not to be so limited since modifications and changes can be made therein which are within the full intended scope of the invention.

I claim:

1. An improved slap hammer having a staple magazine and a stapler body, said stapler body having a forward body end and said staple magazine having a forward staple magazine end, said stapler body being mounted for up and down movement of said forward body end with respect to said forward staple magazine end, said stapler body having a staple driver blade proximate said forward body end for joint motion therewith so as to engagingly drive a staple into a workpiece; wherein the improvement comprises a cap magazine for providing a stacked supply of caps and a cap feeder for feeding a cap from said stacked supply of caps to a stapling position under said staple driver blade; said cap feeder comprising:
(a) a footplate mounted to said slap hammer;
(b) a cap pusher mounted for reciprocation with respect to said footplate from a first position to a second position, said cap pusher having a cap engaging portion for feeding said cap from said stacked supply of caps to said stapling position under said staple driver blade;
(c) a linkage operably connecting said cap pusher to said forward body end such that, when said footplate is in contact with said workpiece and said staple driver blade has driven a staple into said workpiece, said cap pusher is reciprocated by said linkage into said first position preparatory to feeding said cap from said stacked supply of caps, and such that, when said footplate is then removed from contact with said workpiece, said cap pusher, with said cap engaging portion being in engagement with said cap from said stacked supply of caps, is reciprocated by said linkage into said second position as said cap from said stacked supply of caps is moved into said stapling position under said staple driver blade.

2. The improved slap hammer as recited in claim 1, in which said linkage includes a rigid arm having a first arm end and a second arm end, said first arm end being pivotally mounted to said cap pusher and a second arm end being pivotally mounted to said forward body end of said slap hammer.

3. The improved slap hammer as recited in claim 1, in which said cap engaging portion of said cap pusher is a rearwardly-extending finger of said cap pusher.

4. The improved slap hammer as recited in claim 1, in which said cap pusher has left and right tabs that respectively reciprocate within left and right slots in said footplate.

5. The improved slap hammer as recited in claim 1, in which said linkage includes a rigid arm having a first arm end and a second arm end, said first arm end being pivotally mounted to said cap pusher and a second arm end being pivotally mounted to said forward body end of said slap hammer, said cap engaging portion of said cap pusher is a rearwardly-extending finger of said cap pusher, and said cap pusher has left and right tabs that respectively reciprocate within left and right slots in said footplate.

6. The improved slap hammer as recited in claim 1, wherein the improvement further comprises said driver blade being pivotally mounted to said stapler body.
